(19) United States
(12) Patent Application Publication
(10) Pub. No.: US 2026/0071944 A1
(43) Pub. Date: Mar. 12, 2026

(54) IN-SITU TESTING APPARATUS FOR MATERIAL MECHANICAL BEHAVIOR UNDER NEUTRON AND X-RAY FUSION IMAGING

(71) Applicant: Jilin University, Changchun City (CN)

(72) Inventors: Hongwei ZHAO, Changchun City, Jilin Province (CN); Futao HE, Changchun City (CN); Shizhong ZHANG, Changchun City (CN); Hang ZHU, Changchun City (CN); Peng LIU, Changchun City (CN); Min YANG, Changchun City (CN); Heyong HUO, Changchun City (CN); Rongchang CHEN, Changchun City (CN); Hongfu QIANG, Changchun City (CN); Zhiping HUANG, Changchun City (CN); Shuangwei MA, Changchun City (CN); Bingnan YAO, Changchun City (CN)

(21) Appl. No.: 18/961,735

(22) Filed: Nov. 27, 2024

(30) Foreign Application Priority Data
Sep. 9, 2024 (CN) 202411253720.9

(51) Int. Cl. G01N 3/04; G01K 13/00; G01N 23/05; G01N 23/083

(52) U.S. Cl. CPC G01N 3/04; G01K 13/00; G01N 23/05; G01N 23/083; G01N 2203/0206; G01N 2203/0222; G01N 2223/04; G01N 2223/1016; G01N 2223/106; G01N 2223/31

(57) ABSTRACT

Provided is an in-situ testing apparatus for a material mechanical behavior under neutron and X-ray fusion imaging, belonging to that technical field of material mechanical behavior testing. The in-situ testing apparatus includes a mechanical loading test module, a positioning support module, a variable temperature loading module, an X-ray phase contrast imaging module, and a neutron imaging module. The imaging sensitivity is high by adopting X-ray phase contrast imaging. A moving base can drive spatial positions of modules such as a test cassette and a neutron imaging module. A neutron receiver and a neutron upstream emitter can be matched to the same axis, thus solving the problem that the neutron imaging module and the X-ray imaging are difficult to be integrated into one system.

### CROSS-REFERENCE TO RELATED APPLICATION

This patent application claims the benefit and priority of Chinese Patent Application No. 2024112537209, filed with the China National Intellectual Property Administration on Sep. 9, 2024, the disclosure of which is incorporated by reference herein in its entirety as part of the present application.

### TECHNICAL FIELD

The present disclosure relates to the technical field of material mechanical behavior testing, and in particular to an in-situ testing apparatus for a material mechanical behavior under neutron and X-ray fusion imaging.

### BACKGROUND

With the development of science and technology, the requirements for mechanical properties of materials under the action of temperature field, electromagnetic field and complex mechanical load have been significantly improved in aerospace, deep-sea exploration, automobile manufacturing and many other fields. The advanced working condition simulation method and imaging characterization technology are the key to study the structural performance of materials in service and optimize their processes. At present, one of the most advanced characterization means is neutron imaging and X-ray fusion imaging, both of which can both penetrate materials and image internal structures of the materials. For example, the National Institute of Standards and Technology of the United States, the Institute Laue-Langevin of France and the Paul Scherrer Institute of Switzerland have successively developed neutron and X-ray absorption contrast imaging joint technology and apparatus. However, the above neutron and X-ray absorption contrast imaging joint technology and apparatus have three problems at present: First, the imaging sensitivity of X-ray absorption contrast imaging is far less than that of X-ray phase contrast imaging, and the imaging quality is poor. Second, the neutron upstream emitter is an ultra-large apparatus and cannot be moved, which makes it difficult to integrate X-ray imaging and neutron imaging into one system. Third, due to the problem of spatial interference, when testing materials at present, imaging can be carried out only after mechanical loading or temperature loading, so it is impossible to image the mechanical behavior of materials in the loading process, and the characterization accuracy is low.

### SUMMARY

An objective of the present disclosure is to provide an in-situ testing apparatus for a material mechanical behavior under neutron and X-ray fusion imaging for solving the technical problem above. The imaging sensitivity is high by adopting X-ray phase contrast imaging. Spatial positions of modules such as a test cassette and a neutron imaging module can be moved through the moving base, such that the testing apparatus can find a position of a neutron upstream emitter without integrating the neutron upstream emitter and other modules as one device, and the problem that the neutron imaging module and the X-ray imaging are difficult to be integrated into one system. In the mechanical loading process, a loading arm can drive a specimen to rotate 360°, such that the X-ray phase contrast imaging module and the neutron imaging module can complete comprehensive scanning of the specimen in the mechanical loading and heat loading process of the specimen, and the problem that the neutron and X-ray imaging cannot be synchronized with the loading process due to space conflict is solved.

In order to achieve the objective above, the present disclosure provides the following solutions: an in-situ testing apparatus for a material mechanical behavior under neutron and X-ray fusion imaging includes:
a positioning support module, including a moving base seal coverable of moving spatially, where the moving base is provided with a test cassette, a test region for specimen testing is arranged in the test cassette, a left side and a right side of the test cassette are correspondingly provided with a fixture inlet, respectively, and a connecting line between the fixture inlets on the left side and the right side of the test cassette passes through the test region; a top and a bottom of the test cassette are correspondingly provided with an X-ray outlet and an X-ray inlet, respectively, and a connecting line between the X-ray outlet and the X-ray inlet passes through the test region; a front side and a rear side of the test cassette are correspondingly provided with a neutron beam inlet and a neutron beam outlet, respectively, and a connecting line between the neutron beam inlet and the neutron beam outlet passes through the test region;
a mechanical loading test module, including two loading arms seal coverable of rotating around axes thereof, where the two loading arms are mounted on the moving base, and the two loading arms correspond to the fixture inlets on the left side and the right side of the test cassette, respectively; the axes of the two loading arms are coaxial and horizontally arranged, an adjustable clamping spacing is formed between the two loading arms, each loading arm is provided with a fixture located in the clamping spacing, and a pressure sensor is arranged between the loading arm and the fixture, and the fixtures of the two loading arms are used to clamp both ends of the specimen, respectively;
a variable temperature loading module, used to control and monitor a temperature of the specimen, where the variable temperature loading module is arranged on the moving base;
an X-ray phase contrast imaging module, comprising an X-ray emitter, and an X-ray receiver, wherein the X-ray emitter and the X-ray receiver are mounted on the moving base, and located at a lower side and an upper side of the test cassette, respectively; the X-ray emitter is used to emit an X-ray to the X-ray inlet, and the X-ray receiver is used to receive the X-ray emitted from the X-ray outlet; and
a neutron imaging module, comprising a neutron beam receiver, wherein the neutron beam receiver is mounted on the moving base, and located at a rear side of the test cassette, and used to receive a neutron beam emitted from the neutron beam outlet.

Preferably, the positioning support module further includes a portal truss, the X-ray receiver is mounted at the top of the portal truss, and the moving base is mounted on the test cassette through a support frame.

Preferably, the moving base includes a bottom walking platform, a vertical moving platform, a longitudinal moving platform, and a transverse moving platform. The bottom walking platform is placed on the ground through universal wheels with anchors, the vertical moving platform is mounted on the bottom walking platform through a height adjusting mechanism, the longitudinal moving platform is mounted on the vertical moving platform through a horizontal longitudinal moving mechanism, and a horizontal longitudinal direction is parallel to a direction of change of the clamping spacing. The transverse moving platform is mounted on the longitudinal moving platform through a horizontal transverse moving mechanism, and a horizontal transverse direction is perpendicular to the direction of change of the clamping spacing. The portal truss, the support frame and the loading arm are all arranged on the transverse moving platform.

Preferably, the height adjusting mechanism includes a height adjusting handwheel, an adjusting bearing housing, three gearboxes, and four worm-gear elevators. The four worm-gear elevators are arranged on the bottom walking platform in a rectangular shape, the adjusting bearing housing is mounted on the bottom walking platform, and a rotating rod is rotatably connected to the adjusting bearing housing. The height adjusting handwheel is connected to an input port of one of the gearboxes through the rotating rod; two of the four worm-gear elevators form one group. Two output ports of the gearbox between two worm-gear elevators in one group are connected to the two worm-gear elevators in the group through one transmission rod, respectively, and two output ports of the gearbox connected to the rotating rod are connected to input ports of the other two gearboxes through transmission shafts, respectively.

Preferably, the horizontal longitudinal moving mechanism includes a longitudinal adjusting seat, a longitudinal adjusting lead screw, a longitudinal adjusting handwheel, and two longitudinal linear guide rails in horizontal longitudinal arrangement. The longitudinal adjusting seat is fixedly connected to the vertical moving platform, the longitudinal adjusting lead screw is threaded to the longitudinal adjusting seat, and the longitudinal adjusting lead screw is horizontally and longitudinally arranged. The longitudinal adjusting handwheel is fixedly connected to the longitudinal adjusting lead screw, and the longitudinal adjusting lead screw is rotatably connected to the longitudinal moving platform.

Preferably, the horizontal transverse moving mechanism includes a transverse adjusting seat, a transverse adjusting lead screw, a transverse adjusting handwheel, and two transverse linear guide rails in horizontal transverse arrangement. The transverse adjusting seat is fixedly connected to the longitudinal moving platform, the transverse adjusting lead screw is threaded to the transverse adjusting seat, and the transverse adjusting screw is arranged horizontally and transversely. The transverse adjusting handwheel is fixedly connected to the transverse adjusting lead screw, and the transverse adjusting lead screw is rotatably connected to the transverse moving platform.

Preferably, the loading arm includes a loading base, a mechanical rotary table, a loading rod, a support bearing housing, and an electric telescopic cylinder with a built-in grating. The loading base is mounted on the moving base, the loading rod is arranged around a cylinder block of the electric telescopic cylinder, one end of the loading rod is connected to an output end of the mechanical rotary table through an adapter plate, and the other end of the loading rod is fixedly connected to an inner ring of a support bearing in the support bearing housing. The support bearing housing is mounted on the moving base, the cylinder block of the electric telescopic cylinder is fixedly connected to the inner ring of the support bearing, and a piston rod of the electric telescopic cylinder is connected to the fixture through the pressure sensor.

Preferably, the loading base includes an I-shaped steel plate, an L-shaped steel plate, and a mounting bracket. A lower flange of the I-shaped steel plate is mounted on the moving base, and a transverse plate segment of the L-shaped steel plate is mounted on an upper flange of the I-shaped steel plate. The mechanical rotary table is mounted on the transverse plate segment of the L-shaped steel plate, the mechanical rotary table is abutted against a vertical plate segment of the L-shaped steel plate, the mounting bracket is mounted on the transverse plate segment of the L-shaped steel plate, and the support bearing housing is mounted on the transverse plate segment of the L-shaped steel plate.

Preferably, the pressure sensor is fixed to the piston rod of the electric telescopic cylinder through a sensor fixing part, and the pressure sensor is connected to the fixture through a sensor fixing shaft.

Preferably, the fixture includes two semi-circular jackets seal coverable of being combined with each other. Each semi-circular jacket includes a first clamping end, and a second clamping end. The first clamping end is used for being sleeved on the sensor fixing shaft, an outer wall of the first clamping end is provided with locking threads for being threaded to a locking nut, and an inner wall of the second clamping end is provided with an arc-shaped limit plate. A sleeve opening seal coverable of being sleeved on the specimen is arranged between the arc-shaped limit plates of the two combined semi-circular jackets. An end of the specimen is provided with an anti-off convex ring with a diameter greater than that of the sleeve opening.

Preferably, the variable temperature loading module is mounted on the moving base, and includes a refrigerating unit, a heating unit, and a temperature measuring unit. The refrigerating unit includes a nitrogen gas source, the test cassette is provided with a nitrogen inlet and a nitrogen outlet, and the nitrogen inlet communicates with the nitrogen gas source. The heating unit includes an electrified wire connected to a power supply, the fixture is an insulating fixture, the insulating fixture is provided with an electrified wire inlet, and the electrified wire extends into the insulating fixture through the electrified wire inlet. The insulating fixture is used for crimping the electrified wire with the specimen, and the temperature measuring unit is mounted in the test cassette.

Preferably, the temperature measuring unit includes an infrared thermometer mounted in the test cassette, the test cassette is provided with a test wire inlet, and the infrared thermometer is electrically connected to an external test wire through the test wire inlet.

Preferably, the X-ray phase contrast imaging module further includes a vertical linear sliding table, a vertical slider, a receiver mounting plate, and an emitter mounting table. The vertical linear sliding table is vertically mounted at the top of the portal truss, the vertical slider is slidingly connected to the vertical linear sliding table, the X-ray receiver is mounted on the vertical linear sliding table through the receiver mounting plate, the emitter mounting table is mounted on the moving base, and the X-ray emitter is mounted on the emitter mounting table.

Preferably, the neutron imaging module further includes a transverse linear sliding table, a transverse slider, and a neutron mounting table. The neutron mounting table is mounted on the moving base, the transverse linear sliding table is mounted on the neutron mounting table, the transverse slider is slidingly connected to the transverse linear sliding table, and the neutron beam receiver is mounted on the transverse slider.

Preferably, the neutron beam receiver includes a fluorescent screen, an optical path black box, and a receiving camera. The fluorescent screen is mounted at an input end of the optical path black box, and the receiving camera is mounted at an output end of the optical path black box.

Preferably, the test cassette includes a darkroom cavity, and a darkroom seal cover. A front side of the darkroom cavity is provided with a pick-and-place opening for picking and placing the specimen. The darkroom seal cover is hinged at the pick-and-place opening. The fixture inlets are arranged at the left and right sides of the darkroom cavity. The X-ray outlet and the X-ray inlet are arranged at the top and bottom of the darkroom cavity, respectively. The neutron beam inlet is arranged on the darkroom seal cover; and the neutron beam outlet is arranged at a rear side of the darkroom cavity.

Preferably, each of the darkroom cavity and the darkroom seal cover is made of ceramics.

Preferably, the darkroom cavity is connected to the darkroom seal cover by a lock.

Preferably, the X-ray outlet, the X-ray inlet, the neutron beam inlet and the neutron beam outlet are all aluminum alloy interfaces.

Compared with the prior art, the present disclosure has the following technical effects: The in-situ testing apparatus for a material mechanical behavior under neutron and X-ray fusion imaging of the present disclosure has the following advantages: firstly, by adopting the X-ray phase contrast imaging, the imaging sensitivity is higher than that of X-ray absorption contrast imaging, thus ensuring the imaging quality. Secondly, spatial positions of the modules such as the testing cassette and the neutron imaging module can be moved by adjusting the moving base, such that a neutron beam entrance of the test cassette can find a position where a neutron beam emitted by the neutron upstream emitter is located, and the neutron receiver and the neutron upstream emitter can be matched to the same axis. Therefore, the problem that the neutron imaging module and the X-ray imaging are difficult to be integrated into one system as the neutron upstream emitter is a large apparatus incapable of moving can be solved without integrating the neutron upstream emitter and the testing apparatus as one device. Thirdly, the neutron upstream emitter and the neutron beam receiver are arrange on front and rear sides of the test cassette, and an X-ray emitter and an X-ray receive are arranged at upper and lower sides of the test cassette, and the loading arm can drive the specimen to rotate 360° in the mechanical loading process, such that the X-ray phase contrast imaging module and the neutron imaging module can complete the comprehensive scanning of the specimen in the mechanical loading and heat loading process of the specimen, and the problem that neutron and X-ray imaging cannot be synchronized with the loading process due to space conflict is solved. Fourthly, the mechanical loading test module can be used to carry out mechanical loading such as static tension, compression, tension-torsion compound, low-frequency fatigue loading, etc., and the variable temperature loading module can be used to construct a high/low temperature variable temperature environment to carry out heat loading on the specimen. The mechanical loading test module and the variable temperature loading module can be combined to simulate the loading test under near-service conditions, thus achieving the leap from the traditional mechanical testing to in-situ testing under near-service conditions, and the measured test results are more real, reliable and comprehensive. Through the fusion processing of X-ray phase contrast imaging data and neutron imaging data, a three-dimensional model of the specimen under the corresponding loading state can be constructed, and the high-sensitivity in-situ characterization of the macro-fine-microstructure evolution of the specimen can be obtained by combining the analysis of the mechanical loading and ambient temperature loading of the specimen loaded data with the micro-fine-macro structural evolution of the specimen revealed by a reconstruction model. 5. The various modules are integrated in a set of apparatus, which has higher integration and is more convenient to operate.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a three-dimensional structure of a left-front view of an in-situ testing apparatus for a material mechanical behavior under neutron and X-ray fusion imaging in an embodiment;

FIG. 2 is a schematic diagram of loading imaging of an in-situ testing apparatus for a material mechanical behavior under neutron and X-ray fusion imaging in an embodiment.

FIG. 3 is a structural schematic diagram of a positioning support module in an embodiment;

FIG. 4 is a structural schematic diagram of a portal truss in an embodiment;

FIG. 5 is a structural schematic diagram of a moving base in an embodiment;

FIG. 6 is a structural schematic diagram of a bottom walking platform in an embodiment;

FIG. 7 is a structural schematic diagram of a horizontal transverse moving mechanism in an embodiment;

FIG. 8 is a structural schematic diagram of a mechanical loading test module in an embodiment;

FIG. 9 is a schematic diagram of a single-side structure of a mechanical loading test module in an embodiment;

FIG. 10 is an exploded diagram of a single-side structure of a mechanical loading test module in an embodiment;

FIG. 11 is a schematic diagram of a connecting structure of a fixture and a pressure sensor in an embodiment;

FIG. 12 is a structural schematic diagram of a fixture in an embodiment;

FIG. 13 is a schematic diagram of a three-dimensional structure of a right-front view of an in-situ testing apparatus for a material mechanical behavior under neutron and X-ray fusion imaging in an embodiment;

FIG. 14 is a structural schematic diagram of a test cassette in an embodiment;

FIG. 15 is a structural schematic diagram of a test cassette in an embodiment from another perspective;

FIG. 16 is a schematic diagram of a three-dimensional structure of a side view of an in-situ testing apparatus for a material mechanical behavior under neutron and X-ray fusion imaging in an embodiment;

FIG. 17 is a structural schematic diagram of a neutron beam receiver in an embodiment;

FIG. 18 is a structural schematic diagram of a temperature measuring unit in an embodiment;

FIG. 19 is a schematic diagram of temperature control of a variable temperature loading module in an embodiment;

FIG. 20 shows specimen loading principle in an embodiment;

FIG. 21 shows implementation steps of an apparatus in an embodiment;

FIG. 22 is a schematic flow diagram of neutron/X-ray phase contrast fusion imaging in an embodiment (an image shown in the figure is only to distinguish the difference between results of neutron imaging and X-ray phase contrast imaging, but not a real result of neutron and X-ray phase contrast imaging);

FIG. 23 shows a multi-source data fusion flow implemented by a control module in an embodiment;

FIG. 24 shows an implementation method of service condition simulation and mechanical behavior characterization in an embodiment.

In the drawings:
1—positioning support module;
10—moving base; 11—test cassette; 12—portal truss; 13—bottom walking platform; 14—vertical moving platform; 15—longitudinal moving platform; 16—transverse moving platform;
100—darkroom cavity; 101—darkroom seal cover; 102—fixture inlet; 103—X-ray outlet; 104—X-ray inlet; 105—neutron beam inlet; 106—neutron beam outlet; 107—test wire inlet; 108—nitrogen inlet; 109—nitrogen outlet; 110—latch; 111—latch pull rod; 112—handle; 113—hinge; 114—top frame; 115—central hole; 116—middle frame; 117—lower frame; 118—universal wheel; 119—anchor; 120—height adjusting handwheel; 121—adjusting bearing housing; 122—gearbox; 123—worm-gear elevator; 124—rotating rod; 125—transmission rod; 126—coupling; 127—longitudinal adjusting seat; 128—longitudinal adjusting lead screw; 129—longitudinal adjusting handwheel; 130—longitudinal linear guide rail; 131—transverse adjusting seat; 132—transverse adjusting lead screw; 133—transverse adjusting handwheel; 134—transverse linear guide rail; 135—lead screw nut; 136—nut seat; 137—lead screw bearing housing; 138—support frame;
2—mechanical loading test module;
20—loading arm; 21—fixture; 22—pressure sensor; 23—specimen;
200—loading base; 201—mechanical rotary table; 202—loading rod; 203—support bearing housing; 204—support bearing; 205—outer bearing mounting plate; 206—inner bearing mounting plate; 207—electric telescopic cylinder; 208—electric cylinder fixing plate; 209—semi-circular jacket; 210—locking nut; 211—arc-shaped limit plate; 212—electrified wire inlet; 213—sensor fixing part; 214—sensor fixing shaft; 215—sensor nut; 216—adapter plate; 217—anti-off convex ring;
2000—I-shaped steel plate; 2001—L-shaped steel plate; 2002—mounting bracket; 2003—triangular limit plate;
3—variable temperature loading module;
30—infrared thermometer; 31—electrified wire;
4—X-ray phase contrast imaging module;
40—X-ray emitter; 41—X-ray receiver; 42—vertical linear sliding table; 43—vertical slider; 44—receiver mounting plate; 45—emitter mounting table;
5—neutron imaging module;
50—neutron beam receiver; 51—transverse linear sliding table; 52—neutron mounting table; 501—fluorescent screen; 502—optical path black box; 503—receiving camera.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

### Embodiment 1

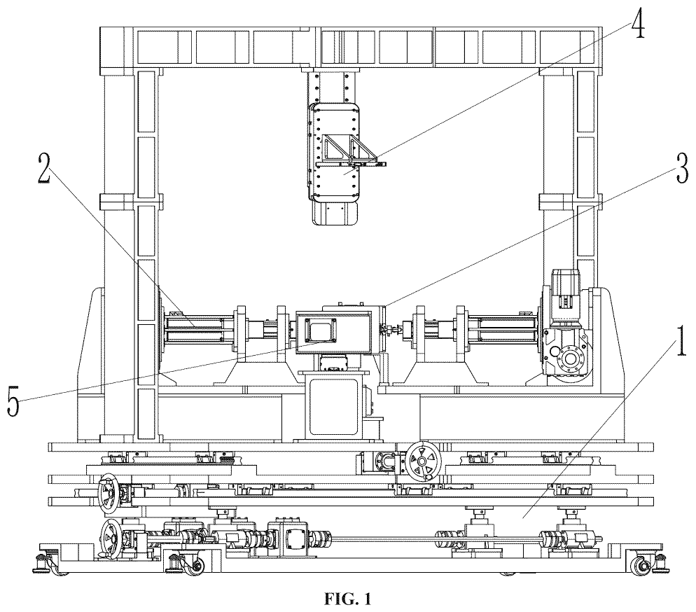

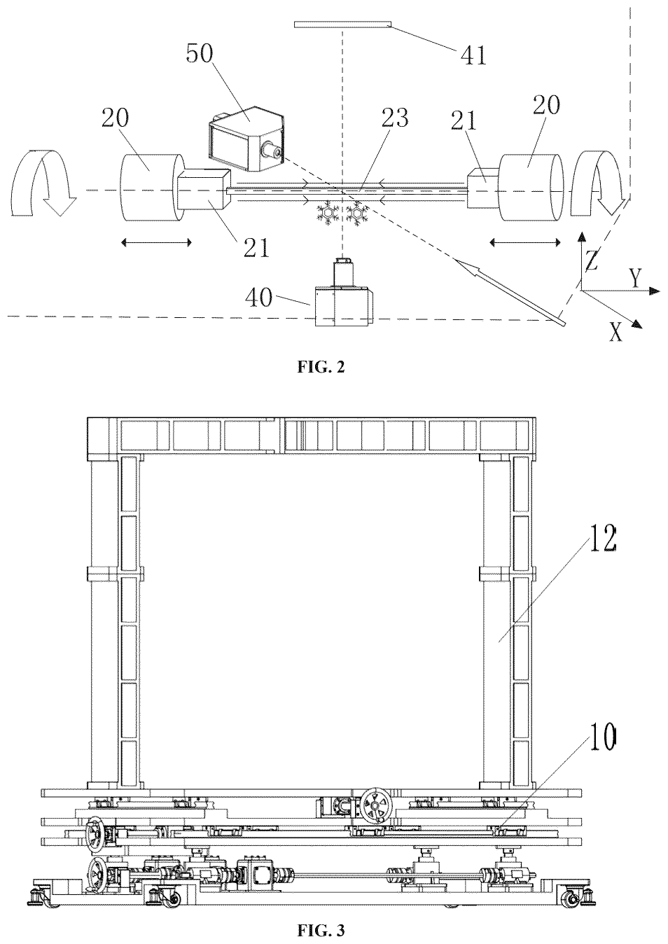

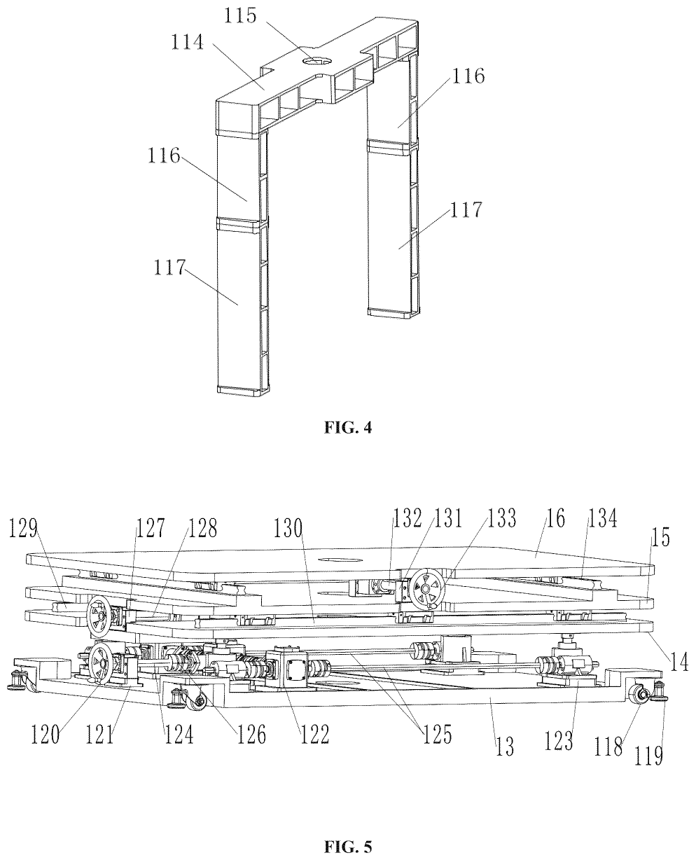

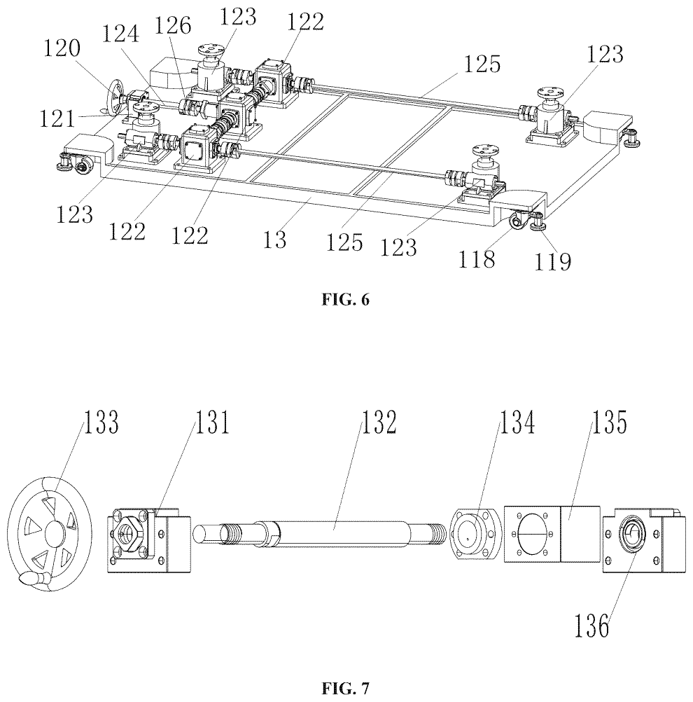

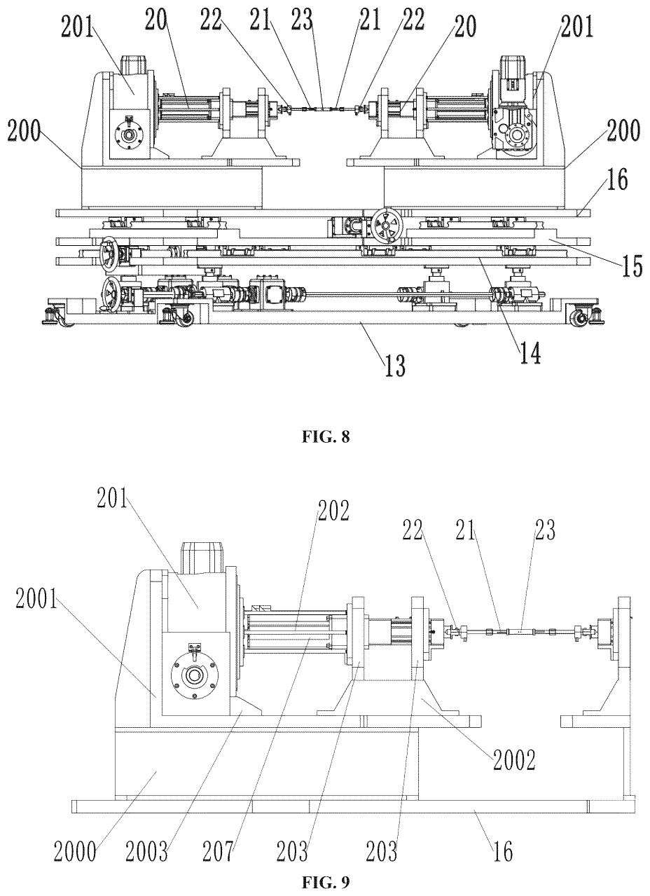

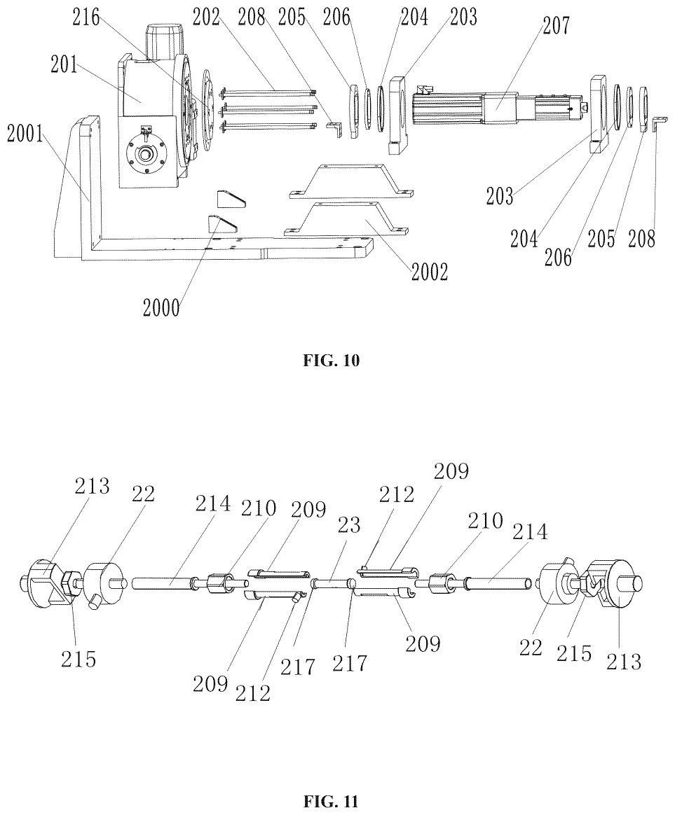

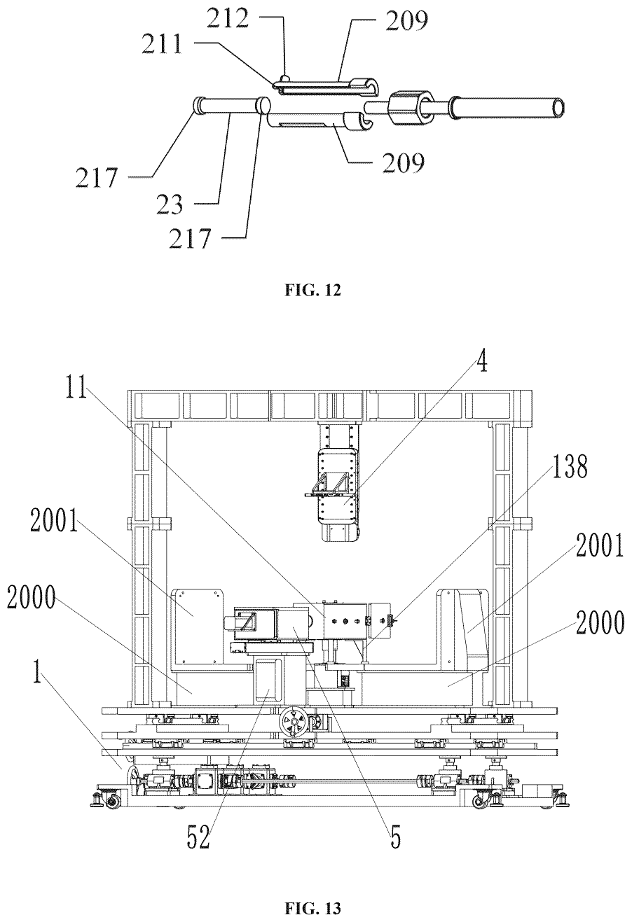

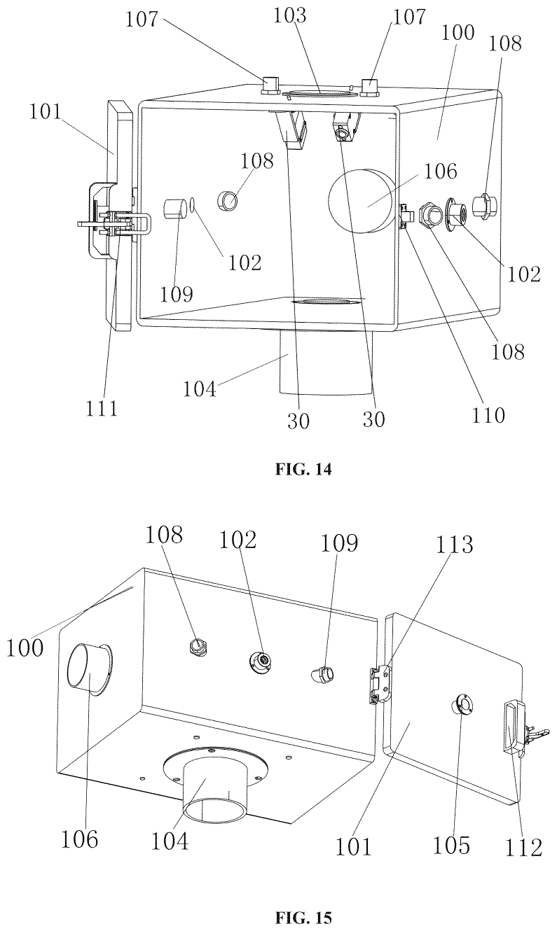

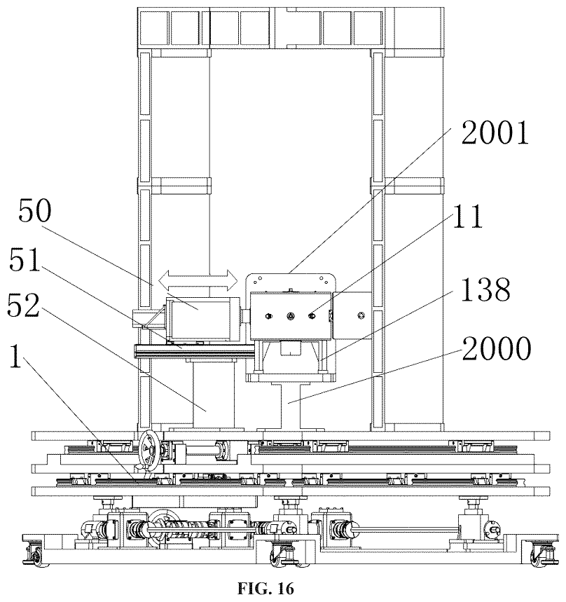

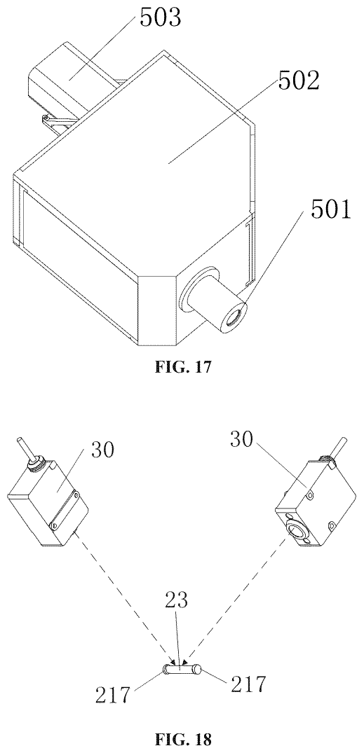

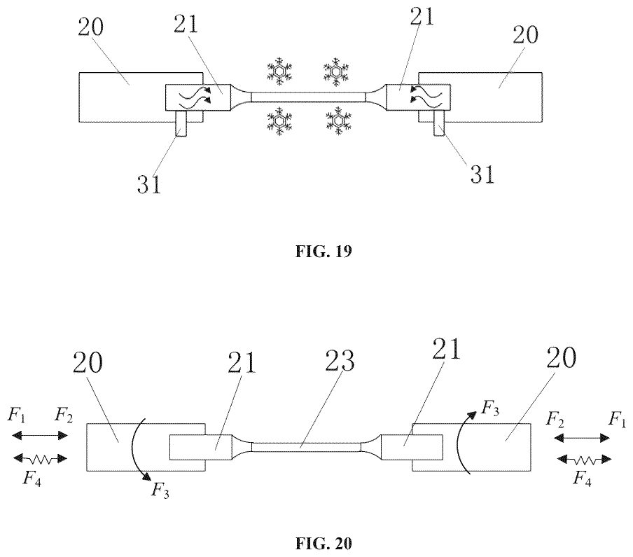

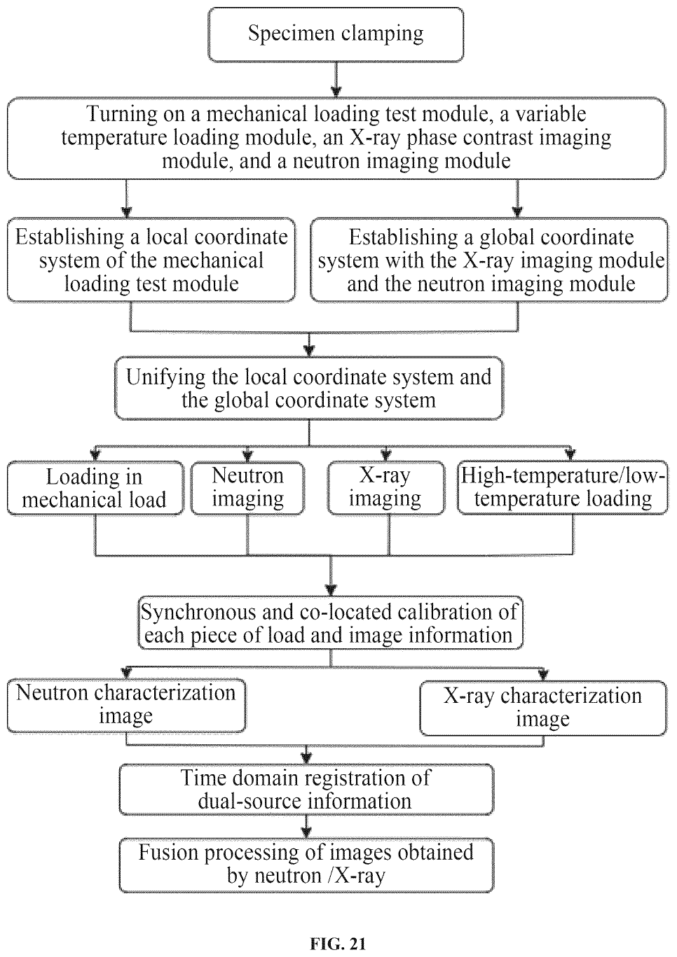

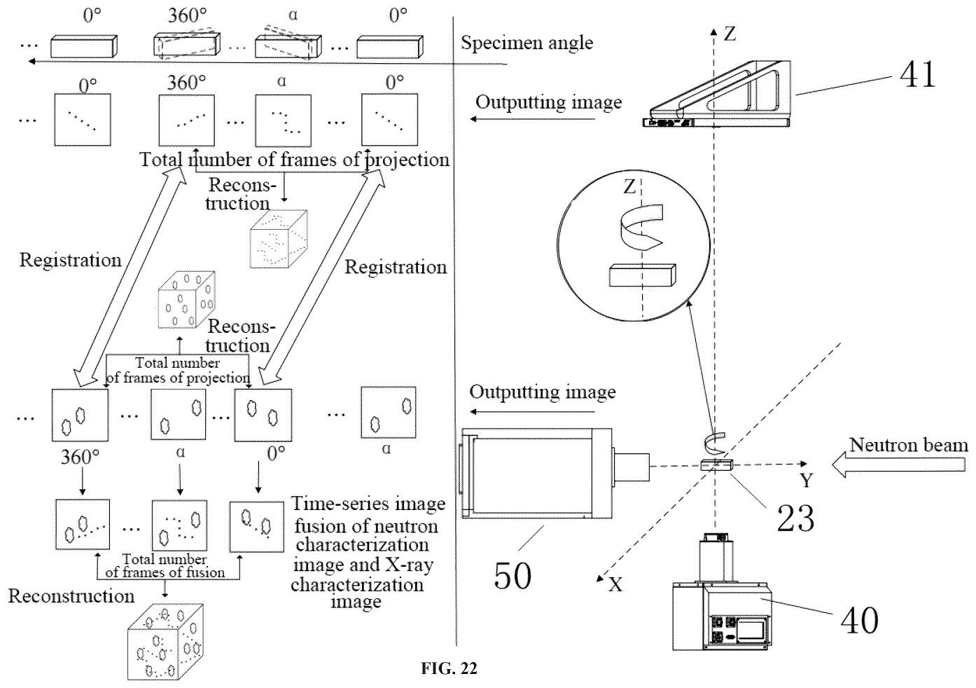

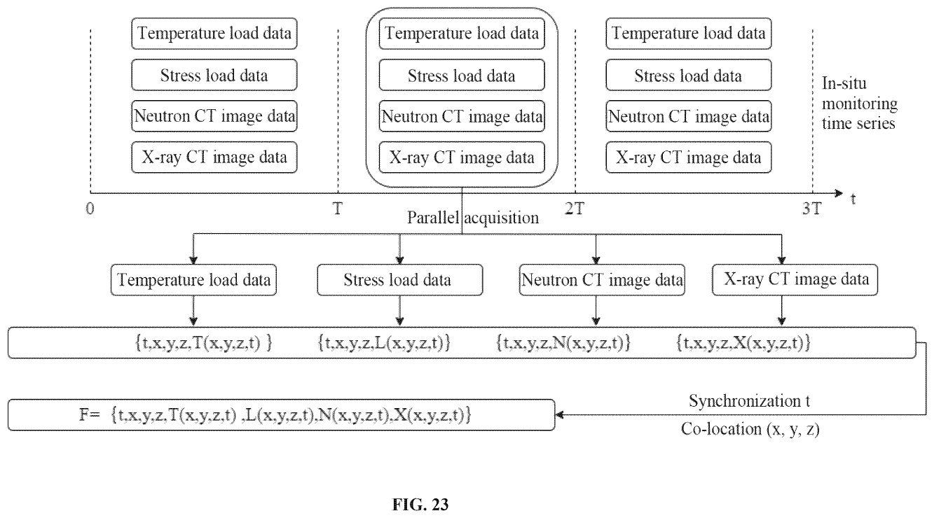

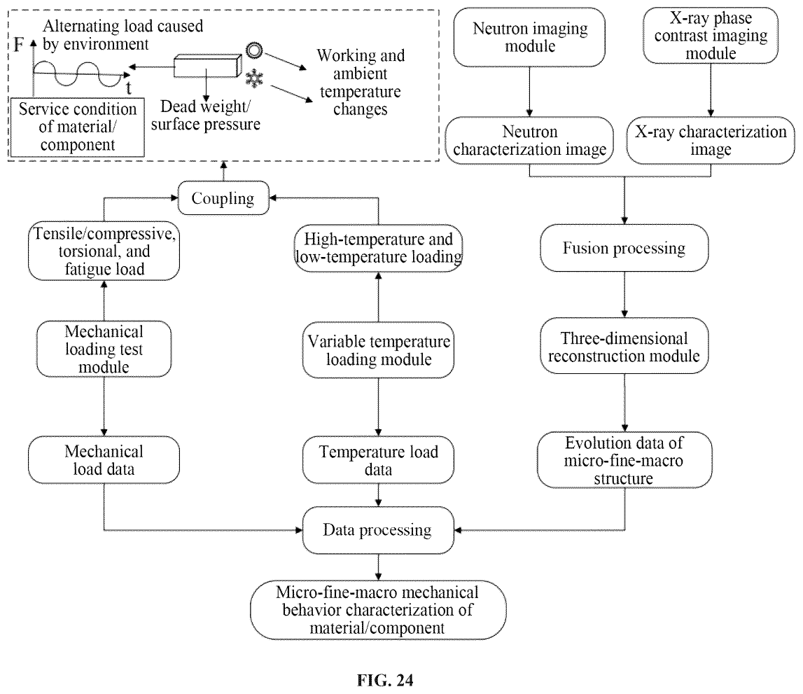

This embodiment provides an in-situ testing apparatus for a material mechanical behavior under neutron and X-ray fusion imaging, as shown in FIG. 1 to FIG. 24, including a positioning support module 1, a mechanical loading test module 2, a variable temperature loading module 3, an X-ray phase contrast imaging module 4, and a neutron imaging module 5.

The positioning support module 1 includes a test cassette 11, the test cassette can spatially move, which can move in a height direction, or a horizontal direction. A test region for specimen 23 testing is arranged in the test cassette 11. A left side and a right side of the test cassette 11 are correspondingly provided with two fixture inlet 102 for the fixture 21 to enter, and a connecting line between the fixture inlets 102 on the left side and the right side of the test cassette 11 passes through the test region. The specimen 23 can be clamped at the test region by the fixtures 21 extending into the test cassette 11. The top and bottom of the test cassette 11 are correspondingly provided with an X-ray outlet 103 and an X-ray inlet 104, respectively, and a connecting line between the X-ray outlet 103 and the X-ray inlet 104 passes through the test region for the entering X-ray to irradiate the specimen 23 and pass through the specimen 23. A front side and a rear side of the test cassette 11 are correspondingly provided with a neutron beam inlet 105 and a neutron beam outlet 106, respectively, and a connecting line between the neutron beam inlet 105 and the neutron beam outlet 106 can pass through the test region for the entering neutron beam to irradiate the specimen 23 and pass through the specimen 23.

The mechanical loading test module 2 includes two loading arms 20, and the two loading arms 20 can rotate around own axes. The two loading arms 20 are mounted on the moving base 10, and correspond to the fixture inlet 102 on the left side of the test cassette 11 and the fixture inlet 102 on the right side of the test cassette 11, respectively. The axes of the two loading arms 20 are horizontally arranged, and coaxially arranged. A clamping spacing is formed between the two loading arms 20, and the size of the clamping spacing can be adjusted. Each of the two loading arms 20 is provided with a fixture 21, and the fixture 21 is located in the clamping spacing between the two loading arms 20. A pressure sensor 22 is arranged between the loading arm 20 and the fixture 21. During test, the fixtures 21 of the two loading arms 20 need to clamp both ends of the specimen 23. By rotating the loading arm 20 and adjusting the clamping spacing, the tensile, compressive, torsional or low-frequency fatigue loading of the specimen 23 can be achieved.

The variable temperature loading module 3 is used to control and monitor a temperature of the specimen 23, thus achieving the variable temperature loading and recording of the specimen 23.

The X-ray phase contrast imaging module 4 includes an X-ray emitter 40, and an X-ray receiver 41. The X-ray emitter 40 and the X-ray receiver 41 are mounted on the moving base 10, the X-ray emitter 40 is located at a lower side of the test cassette 11, that is, the X-ray emitter 40 can extend into the X-ray inlet 104 to emit an X-ray and is used to the X-ray inlet 104. The X-ray receiver 41 is located at an upper side the test cassette 11, that is, the X-ray receiver 41 is located above the X-ray outlet 103, and is used to receive the X-ray emitted from the X-ray outlet 103, thus forming X-ray phase contrast imaging.

The neutron imaging module 5 includes a neutron beam receiver 50. The neutron beam receiver 50 is mounted on the moving base 10, located at a rear side of the test cassette 11, and used to receive a neutron beam emitted from the neutron beam outlet 106, thus forming neutron imaging.

The operation principle is as follows:

Firstly, the whole testing apparatus is entirely moved to an emission end of the neutron upstream emitter by the moving base 10. Then, a spatial position of the test cassette 11 is adjusted by the moving base 10, such that the neutron beam inlet 105 of the test cassette 11 is aligned with the emission end of the neutron upstream emitter. Afterwards, the specimen 23 is clamped on the fixtures 21 of the two loading arms 20, making the specimen 23 located at the test region of the test cassette 11. The mechanical loading test module 2, the variable temperature loading module 3, the X-ray phase contrast imaging module 4, the neutron imaging module 5 and the neutron upstream emitter are started, neutron beams and X-rays are irradiated on the specimen 23, and the variable temperature loading module 3 is used to set a preset temperature to change the temperature of the specimen 23. Subsequently, the clamping spacing between the two loading arms 20 is increased (tensile loading is achieved) or decreased (experimental compressive loading is achieved), the loading arms 20 start to rotate at the same time, and the neutron beam and the X-ray scan the sample 23 by 360°. Under the clamping of the fixtures 21, the specimen 23 starts to rotate continuously at 0-360°, thus achieving 0-360° continuous imaging of the specimen 23; and meanwhile, a deformation value of the specimen 23, a value of the pressure sensor 22, neutron imaging data and X-ray phase contrast imaging data are recorded. A three-dimensional mode of the specimen 23 under a corresponding loaded state can be constructed through fusion processing of the X-ray phase contrast imaging data and the neutron imaging data. The purpose of macro-fine-micro multi-scale characterization of the mechanical behaviors of the specimen 23 can be achieved by combining the analysis of all loaded data (mechanical load loading, ambient environment loading) of the specimen 23 mechanical loading and ambient temperature loading of the specimen loaded data with the micro-fine-macro structural evolution of the specimen 23 revealed by a reconstruction model, and high-sensitivity in-situ characterization of the macro-fine-microstructure evolution of the specimen under near-service conditions (mechanical load loading, ambient environment loading) can be obtained.

In an embodiment, as shown in FIG. 1 to FIG. 24, the X-ray emitter 40, the X-ray receiver 41, the X-ray inlet 104 and the X-ray outlet 103 are coaxially arranged. The neutron beam receiver 50, the neutron beam inlet 105 and the neutron beam outlet 106 are coaxially arranged.

In an embodiment, as shown in FIG. 1 to FIG. 24, the positioning support module 1 further includes a portal truss 12. The X-ray receiver 41 is mounted at the top of the portal truss 12, and the neutron beam receiver 50 is mounted on the moving base 10. The test cassette 11 is mounted on the moving base 10 through a support frame 138, and the test cassette 11 can be spatially moved through the moving base 10.

In an embodiment, as shown in FIG. 1 to FIG. 24, the portal truss 12 includes a top frame 114, two middle frames 116, and two lower frames 117. The lower frame 117 and the middle frames 116 form one group from bottom to top as two side walls of the portal truss 12, respectively. Both ends of the top frame 114 are mounted on the two middle frames 116, and the middle of the top frame 114 is provided with a central hole 115 for mounting the X-ray receiver 41.

In an embodiment, as shown in FIG. 1 to FIG. 24, the moving base 10 includes a bottom walking platform 13, a vertical moving platform 14, a longitudinal moving platform 15, and a transverse moving platform 16. The bottom walking platform 13 is placed on the ground by universal wheels 118 with anchors 119. The universal wheel 118 has two modes, one is that the anchor 119 is in contact with the ground to achieve the function of keeping the bottom walking platform 13 motionless, and the other is that the universal wheel 118 is in contact with the ground to achieve the walking function of the bottom walking platform 13. The vertical moving platform 14 is mounted on the bottom walking platform 13 through a height adjusting mechanism, and a height of the vertical moving platform 14 can be adjusted by the height adjusting mechanism, where the height direction is a Z-axis direction. The longitudinal moving platform 15 is mounted on the vertical moving platform 14 through a horizontal longitudinal moving mechanism, a horizontal longitudinal movement of the longitudinal moving platform 15 can be achieved through the horizontal longitudinal moving mechanism, a horizontal longitudinal direction is parallel to a direction of change of the clamping spacing, and the horizontal longitudinal direction is set as a Y-axis direction. The transverse moving platform 16 is mounted on the longitudinal moving platform 15 through a horizontal transverse moving mechanism, a horizontal transverse movement of the transverse moving platform 16 can be achieved through the horizontal transverse moving mechanism, a horizontal transverse direction is parallel to a direction of change of the clamping spacing, and the horizontal transverse direction is set as an X-axis direction. The portal truss 12, the support frame 138, the loading arm 20 and the neutron beam receiver 50 are all arranged on the transverse moving platform 16. The spatial position of the test cassette 11 can be adjusted through the bottom walking platform 13, the vertical moving platform 14, the longitudinal moving platform 15 and the transverse moving platform 16, thus ensuring that a neutron beam can enter from the neutral beam inlet 105 of the test cassette 11 to hit the specimen 23, and can be emitted from the neutron beam outlet 106 and received by the neutron beam receiver 50.

In an embodiment, as shown in FIG. 1 to FIG. 24, the height adjusting mechanism includes a height adjusting handwheel 120, an adjusting bearing housing 121, three gearboxes 122, four worm-gear elevators 123, a rotating rod 124, and four transmission rods 125. The four worm-gear elevators 123 are arranged on the bottom walking platform 13 in a rectangular shape. Two of the four worm-gear elevators 123 form one group, and two gearboxes 122 are respectively arranged between the two groups of worm-gear elevators 123, respectively. Output ports of the gearbox 122 between two worm-gear elevators 123 in one group are connected to the two worm-gear elevators 123 in the group through one transmission rod 125, respectively; and then input ports of the two gearboxes 122 are connected to two output ports of the third gearbox 122. The adjusting bearing housing 121 is mounted on the bottom walking platform 13, and located between the height adjusting handwheel 120 and the third gearbox 122. The rotating rod 124 is rotatably connected to the adjusting bearing housing 121, and the height adjusting handwheel 120 is connected to an input port of the third gearbox 122 through the rotating rod 124. In addition to that, the height adjusting mechanism may also employ a jack, a scissor lifting platform, and other lifting modes.

In an embodiment, as shown in FIG. 1 to FIG. 24, one end of the rotating rod 124 is fixedly connected to the height adjusting handwheel 120, the other end of the rotating rod 124 is connected to the input port of the gearbox 122 through the coupling 126. The transmission rod 125 is connected to the output port of the gearbox 122 and the worm-gear elevator 123 by the coupling 126.

In an embodiment, as shown in FIG. 1 to FIG. 24, the horizontal longitudinal moving mechanism includes a longitudinal adjusting seat 127, a longitudinal adjusting lead screw 128, a longitudinal adjusting handwheel 129, and two longitudinal linear guide rails 130. The two longitudinal linear guide rails 130 are mounted on the vertical moving platform 14, and the two longitudinal linear guide rails 130 are horizontally and longitudinally arranged (i.e., in a Y-axis direction). The longitudinal moving platform 150 is slidingly connected to the two longitudinal linear guide rails 130 through guide rail sliders. The longitudinal adjusting seat 127 is fixedly connected to the vertical moving platform 14, and the fixed connection here may be welding, bolting, riveting, and the like. The longitudinal adjusting seat 127 is located between the two longitudinal linear guide rails 130. The longitudinal adjusting lead screw 128 is threaded to the longitudinal adjusting seat 127, the longitudinal adjusting lead screw 128 is horizontally and longitudinally arranged (i.e., in the Y-axis direction). The longitudinal adjusting handwheel 129 is fixedly connected to the longitudinal adjusting lead screw 128, and the longitudinal adjusting lead screw 128 is rotatably connected to the longitudinal moving platform 15. By rotating the longitudinal adjusting handwheel 129, the longitudinal adjusting lead screw 128 can be driven to rotate. Under the fitting of the threads of the longitudinal adjusting lead screw 128 and the longitudinal adjusting seat 127, the longitudinal adjusting lead screw 128 is converted to move in an axial direction, thereby driving the longitudinal moving platform 15 to move horizontally and longitudinally, i.e., moving in the Y-axis direction. In addition to that, the horizontal longitudinal moving mechanism may also employ a movement mode of replacing the longitudinal adjusting lead screw 128 with a telescopic cylinder.

In an embodiment, as shown in FIG. 1 to FIG. 24, the bottom of the longitudinal moving platform 15 is provided with a lead screw bearing housing 137 and a nut seat 136, and a lead screw nut 135 is mounted on the nut seat 136. One end of the longitudinal adjusting lead screw 128 is threaded to the longitudinal adjusting seat 127, and the other end of the longitudinal adjusting screw 128 is threaded to the lead screw nut 135 and passes through the nut seat 136, and the part passing through the nut seat 136 is rotatably connected to the lead screw bearing housing 137.

In an embodiment, as shown in FIG. 1 to FIG. 24, the horizontal longitudinal moving mechanism includes a transverse adjusting seat 131, a transverse adjusting lead screw 132, a transverse adjusting handwheel 133, and two transverse linear guide rails 134. The two transverse linear guide rails 134 are mounted on the longitudinal moving platform 15, and the two transverse linear guide rails 134 are horizontally and transversely arranged (i.e., in an X-axis direction). The transverse moving platform 16 is slidingly connected to the two transverse linear guide rails 134 through guide rail sliders. The transverse adjusting seat 131 is fixedly connected to the longitudinal moving platform 15, and the fixed connection here may be welding, bolting, riveting, and the like. The transverse adjusting seat 131 is located between the two transverse linear guide rails 134. The transverse adjusting lead screw 132 is threaded to the transverse adjusting seat 131, the transverse adjusting lead screw 132 is horizontally and transversely arranged (i.e., in the X-axis direction). The transverse adjusting handwheel 133 is fixedly connected to the transverse adjusting lead screw 132, and the transverse adjusting lead screw 132 is rotatably connected to the transverse moving platform 16. By rotating the transverse adjusting handwheel 133, the transverse adjusting lead screw 132 can be driven to rotate. Under the fitting of threads of the transverse adjusting screw 132 and the transverse adjusting seat 131, the transverse adjusting lead screw 132 is converted to move in an axial direction, thus driving the longitudinal moving platform 15 to move horizontally and transversely, i.e., in the X-axis direction. In addition to that, the horizontal transverse moving mechanism may also employ a movement mode of replacing the transverse adjusting lead screw 132 with a telescopic cylinder.

In an embodiment, as shown in FIG. 1 to FIG. 24, the bottom of the transverse moving platform 16 is provided with a lead screw bearing housing 137 and a nut seat 136, and a lead screw nut 135 is mounted on the nut seat 136. One end of the transverse adjusting lead screw 132 is threaded to the longitudinal adjusting seat 127, and the other end of the transverse adjusting lead screw 132 is threaded to the lead screw nut 135 and passes through the nut seat 136, and the part passing through the nut seat 136 is rotatably connected to the lead screw bearing housing 137.

In an embodiment, as shown in FIG. 1 to FIG. 24, the loading arm 20 includes a loading base 200, a mechanical rotary table 201, a loading rod 202, a support bearing housing 203, and an electric telescopic cylinder 207. A grating is built in the electric telescopic cylinder 207. The loading base 200 is mounted on the moving base 10, and if there is the transverse moving platform 16, the loading base 200 is mounted on the transverse moving platform 16. Multiple loading rods 202 are arranged around a cylinder block of the electric telescopic cylinder 207, one end of each loading rod 202 is connected to an output end of the mechanical rotary table 201 through an adapter plate 216, and the other end of the loading rod 202 is fixedly connected to an inner ring of a support bearing 204 in the support bearing housing 203. The support bearing housing 203 is mounted on the moving base 10, if there is the transverse moving platform 16, the support bearing housing 203 is mounted on the transverse moving platform 16. The cylinder block of the electric telescopic cylinder 207 is fixedly connected to the inner ring of the support bearing 204, and a piston rod of the electric telescopic cylinder 207 is connected to the fixture 21 through the pressure sensor 22. Multiple support bearing housings 203 can be provided to improve the stability of the electric telescopic cylinder 207. For example, if two support bearing housing 203 are provided, one support bearing housing 203 is used to support a middle part of the electric telescopic cylinder 207, and the other support bearing housing 203 is used to support one end, close to the piston rod, of the electric telescopic cylinder 207. The mechanical rotary table 201 is started, and the rotation of an output end of the mechanical rotary table 201 drives the electric telescopic cylinder 207 to rotate, thus driving the fixture 21 to rotate to achieve the auto-rotation of the specimen 23. The extension and retraction of the electric telescopic cylinder 207 can change the clamping spacing between the two loading arms 20, thus making the fixtures 21 pull or compress the specimen 23. The electric telescopic cylinders 207 on the two loading arms 20 are symmetrically arranged with respect to the specimen 23. During test, the electric telescopic cylinders 207 on the two loading arms 20 may act independently to carry out tensile, compressive, torsional or low-frequency fatigue loading on one end of the specimen 23, or act synchronously to carry out static/dynamic tensile/compressive or low-frequency fatigue loading on both ends of the specimen 23, thus ensuring that the center of the specimen 23 does not shift in the loading process. The built-in grating of the electric telescopic cylinder 207 can measure the deformation of the specimen 23, the stress data of the specimen 23 can be obtained by the pressure sensor 22, and all the loaded data of the specimen 23 can be obtained by combining the temperature load applied to the specimen 23 by the variable temperature loading module 3.

In an embodiment, as shown in FIG. 1 to FIG. 24, the adapter plate 216 is mounted on an output port of the mechanical rotary table 201 by a screw. One end of the loading rod 202 is connected to the adapter plate 216 by a bolt, and the other end of the loading rod 202 is machined with threads. An inner bearing mounting plate 206 is fixed to the inner ring of the support bearing 204, and an outer bearing mounting plate 205 is connected to the inner bearing mounting plate 206 by a bolt. The outer bearing mounting plate 205 is provided with a threaded hole, and is threaded to a threaded end of the loading rod 202 by the threaded hole. The cylinder block of the electric telescopic cylinder 207 is fixedly connected to the outer bearing mounting plate 205 through an electric cylinder fixing plate 208.

In an embodiment, as shown in FIG. 1 to FIG. 24, the loading base 200 includes an I-shaped steel plate 2000, an L-shaped steel plate 2001, and a mounting bracket 2002. A lower flange of the I-shaped steel plate 2000 is mounted on the moving base 10, if there is a transverse moving platform, the lower flange of the I-shaped steel plate is mounted on the transverse moving platform 16. A transverse plate segment of the L-shaped steel plate 2001 is mounted on an upper flange of the I-shaped steel plate 2000. The mechanical rotary table 201 is mounted on the transverse plate segment of the L-shaped steel plate 2001, is abutted against a vertical plate segment of the L-shaped steel plate 2001, thus limiting the mechanical rotary table 201. The mounting bracket 2002 is mounted on the transverse plate segment of the L-shaped steel plate 2001, and the support bearing housing 203 is mounted on the mounting bracket 2002. The above mounting mode includes welding, bolted connection, riveting and the like.

In an embodiment, as shown in FIG. 1 to FIG. 24, the test cassette 11 is fixedly connected to the transverse plate segment of the L-shaped steel plate 2001 of each of the two loading arms 20 by the support frame 138.

In an embodiment, as shown in FIG. 1 to FIG. 24, the L-shaped steel plate 2001 is further provided with triangular limit plates 2003 located on both sides of the mechanical rotary table 201, thus limiting the X-axis direction of the mechanical rotary table 201.

In an embodiment, as shown in FIG. 1 to FIG. 24, the pressure sensor 22 is fixed to the piston rod of the electric telescopic cylinder 207 through a sensor fixing part 213, and the pressure sensor 22 is connected to the fixture 21 through a sensor fixing shaft 214.

In an embodiment, as shown in FIG. 1 to FIG. 24, the pressure sensor 22 is connected to the sensor fixing part 213 through the sensor nut 215. The sensor fixing shaft 214 is machined with internal threads, a sensing shaft of the pressure sensor 22 is machined with external threads, and the sensor fixing shaft 214 is connected to the sensing shaft of the pressure sensor 22 through the internal and external threads.

In an embodiment, as shown in FIG. 1 to FIG. 24, the fixture 21 may include two semi-circular jackets 209, and the two semi-circular jackets 209 are combined to form a complete fixture 21. The semi-circular jacket 209 includes a first clamping end and a second clamping end. The first clamping end is used to be sleeved on the sensor fixing shaft 214, and an outer wall of the first clamping end is provided with locking threads. An inner wall of the second clamping end is provided with an arc-shaped limit plate 211, and a sleeve opening is formed between the arc-shaped limit plates 211 of the two combined semi-circular jackets 209. Both ends of the specimen 23 are provided with anti-off convex rings 217, and a diameter of the anti-off convex ring 217 is greater than that of the sleeve opening. During use, the first clamping ends of the two semi-circular jackets 209 are sleeved on the sensor fixing shaft 214, and the second clamping ends of the two semi-circular jackets 209 are sleeved on the specimen 23; then the locking nut 210 is screwed into the locking threads of the first clamping ends, and finally the two semi-circular jackets 209 clamp the sensor fixing shaft 214 and the specimen 23. The specimen 23 cannot be separated from the fixture 21 in the fitting of the anti-off convex ring 217 and the sleeve opening of the arc-shaped limit plate 211.

In an embodiment, as shown in FIG. 1 to FIG. 24, the variable temperature loading module 3 is mounted on the moving base 10. The variable temperature loading module 3 includes a refrigerating unit, a heating unit, and a temperature measuring unit. The refrigerating unit includes a nitrogen gas source. The test cassette 11 is provided with a nitrogen inlet 108, and a nitrogen outlet 109. The nitrogen inlet 108 communicates with the nitrogen gas source, such that a low-temperature gas atmosphere can be constructed in the test cassette 11 to achieve low-temperature loading of the specimen 23. The number of the nitrogen inlets 108 and the nitrogen outlets 109 is not limited, and there may be one or multiple nitrogen inlets 108 and one or multiple nitrogen outlets 109. The refrigerating unit includes an electrified wire 31, and the electrified wire 31 is connected to a power supply. The fixture 21 is an insulating fixture which is provided with an electrified wire inlet 212. The electrified wire 31 extends into the insulating fixture through the electrified wire inlet 212. The insulating fixture is used for crimping the electrified wire 31 with the specimen 23, thus electrically heating the specimen 23 to achieve high-temperature loading. If the fixture 21 is in the form of two semi-circular jackets 209, the electrified wire inlet 212 is arbitrarily formed in one of the two semi-circular jackets 209, and the two semi-circular jackets 209 are buckled after the specimen 23 is mounted, thus ensuring that the electrified wire 31 is tightly pressed against the specimen 23. The temperature measuring unit is mounted in the test cassette 11 to monitor the temperature of the specimen 23 in real time.

In an embodiment, as shown In FIG. 1 to FIG. 24, the temperature measuring unit includes an infrared thermometer 30, which is mounted in the test cassette 11. The test cassette 11 is provided with a test wire inlet 107, and the infrared thermometer 30 is electrically connected to an external test wire through the test wire inlet 107. There may be one or more infrared thermometers 30. For example, two infrared thermometers 30 are provided, which are fixed to a top wall of the test cassette 11 by screws, and temperature measuring points of the two infrared thermometers 30 intersect at the theoretical center point of the specimen 23.

In an embodiment, as shown in FIG. 1 to FIG. 24, the X-ray phase contrast imaging module 4 further includes a vertical linear sliding table 42, a vertical slider 43, a receiver mounting plate 44, and an emitter mounting table 45. The vertical linear sliding table 42 is vertically mounted at the top of the portal truss 12, and the vertical linear sliding table 42 is mounted at the central hole 115 if there is a central hole 115. The vertical slider 43 is slidingly connected to the vertical linear sliding table 42, and the receiver mounting plate 44 is mounted on the vertical slider 43. The X-ray receiver 41 is mounted at the receiver mounting plate 44. The emitter mounting table 45 is mounted on the moving base 10, and if the moving base 10 has a transverse moving platform 16, the emitter mounting table 45 is mounted on the transverse moving platform 16. The X-ray receiver 41 and the X-ray emitter 40 are coaxially arranged, and the corresponding X-ray outlet 103 and X-ray inlet 104 are coaxially arranged. The X-ray emitter 40 can extend into the X-ray inlet 104. The above mounting includes welding, bolted connection, riveting and the like. Due to the principle of X-ray phase contrast imaging, in order to meet the requirements of high-resolution imaging of the specimen 23, a position of the X-ray receiver 41 in the vertical direction is adjusted by sliding the vertical slider 43 up and down (moving along the Z-axis direction), and then the requirements of the X-ray receiver 41 and the X-ray emitter 40 for the separation distance are satisfied. After passing through the specimen 23, the X-ray emitted by the X-ray emitter 40 passes through the X-ray outlet 103 and is received by the X-ray receiver 41, thus completing X-ray scanning of the specimen 23 and achieving the X-ray phase contrast imaging.

In an embodiment, as shown in FIG. 1 to FIG. 24, the neutron imaging module 5 further includes a transverse linear sliding table 51, a transverse slider, and a neutron mounting table 52. The neutron mounting table 52 is mounted on the moving base 10, and if the moving base 10 has a transverse moving platform 16, the neutron mounting table 52 is mounted on the transverse moving platform 16. The transverse linear sliding table 51 is mounted on the neutron mounting table 52, the transverse slider is slidingly connected to the transverse linear sliding table 51, and the neutron beam receiver 50 is mounted on the transverse slider. The above mounting includes welding, bolted connection, riveting and the like. A position of the neutron beam receiver 50 is adjusted through the transverse slider, such that the neutron beam receiver 50 can extend into the neutron beam outlet 106 of the test cassette 11 and is as close as possible to the specimen 23 to meet the requirement of imaging resolution. A neutron beam emitted by a neutron upstream emitter, after hitting the specimen 23 through the neutron beam inlet 105, is received by the neutron beam receiver 50, thus completing CT tomography of the specimen 23 and achieving neutron imaging.

In an embodiment, as shown in FIG. 1 to FIG. 24, the neutron beam receiver 50 includes a fluorescent screen 501, an optical path black box 502, and a receiving camera 503. The fluorescent screen 501 is mounted at an input end of the optical path black box 502, and the receiving camera 503 is mounted at an output end of the optical path black box 502. The neutron beam, after hitting the specimen 23, is first received by the fluorescent screen 501 and converted into visible light, and then is received by the receiving camera 503 through the optical path black box 502, thus completing CT tomography and achieving neutron imaging.

In an embodiment, as shown in FIG. 1 to FIG. 24, the test cassette 11 includes a darkroom cavity 100, and a darkroom seal cover 101. A front side of the darkroom cavity 100 is provided with a pick-and-place port for picking and placing the specimen 23, and the darkroom seal cover 10 is hinged to the pick-and-place port. A left side and a right side of the darkroom cavity 100 are provided with a fixture inlet 102, respectively. The X-ray outlet 103 and the X-ray inlet 104 are arranged at the top and bottom of darkroom cavity 100, respectively, and the X-ray outlet 103 and the X-ray inlet 104 are coaxially arranged. The neutron beam inlet 105 is arranged on the darkroom seal cover 101, the neutron beam outlet 106 is arranged on a rear side of the darkroom cavity 100.

In an embodiment, as shown in FIG. 1 to FIG. 24, the darkroom cavity 100 and the darkroom cover 101 are hinged by a hinge 113.

In an embodiment, as shown in FIG. 1 to FIG. 24, the right side of the darkroom cavity 100 is provided with two nitrogen inlets 108, and the left side of the darkroom cavity 100 is provided with a nitrogen inlet 108, and a nitrogen outlet 109.

In an embodiment, as shown in FIG. 1 to FIG. 24, each of the darkroom cavity 100 and the darkroom cover 101 is made of ceramics, which is used for preventing electromagnetic interference and ensuring the smooth operation of electric heating.

In an embodiment, as shown in FIG. 1 to FIG. 24, a handle 112 is mounted on the darkroom seal cover 101, which is used for an operator to open and close the darkroom cavity 100 and the darkroom seal cover 101.

In an embodiment, as shown in FIG. 1 to FIG. 24, the darkroom cavity 100 and the darkroom cover 101 are connected by a lock. The lock includes a latch 110, and a latch pull rod 111. The latch 110 is mounted on the right side or left side of the darkroom cavity 100, and the latch pull rod 111 is mounted on the darkroom seal cover 101. The latch pull rod 111 and the latch are in cooperation to achieve locking and unlocking. The above mounting includes welding, bolted connection, riveting and the like.

In an embodiment, as shown in FIG. 1 to FIG. 24, the X-ray outlet 103, the X-ray inlet 104, the neutron beam inlet 105 and the neutron beam outlet 106 all employ aluminum alloy interfaces, thus reducing the interference of the X-ray and the neutron.

In an embodiment, as shown in FIG. 1 to FIG. 24, the test wire inlet 107, the nitrogen inlet 108 and the nitrogen outlet 109 are all machined with threads on one side and threaded to the darkroom cavity 100. The X-ray outlet 103 and the X-ray inlet 104 are connected to the darkroom cavity 100 by bolts. The fixture inlet 102 is rigidly connected to the darkroom cavity 100 by the screw, and the fixture inlet 102 and the darkroom cavity 100 are sealed. The neutron beam inlet 105 is mounted on the darkroom cavity 100 by the screw, and the neutron beam outlet 106 is mounted on the darkroom cavity 100 by the screw.

### Embodiment 2

This embodiment provides an in-situ testing method for a material mechanical behavior under neutron and X-ray fusion imaging. The in-situ testing apparatus for a material mechanical behavior under neutron and X-ray fusion imaging in Embodiment 1 is used for testing, as shown in FIG. 1 to FIG. 24, including the following steps:
Step 1. Mounting of specimen: both ends of a specimen 23 are clamped by fixtures 21 of two loading arms 20.
Step 2. Turn-on of each module and calibration of spatial coordinate system: a mechanical loading test module 2, a variable temperature loading module 3, an X-ray phase contrast imaging module 4 and a neutron imaging module 5 are turned on. The mechanical loading test module 2 and the variable temperature loading module 3 form a local coordinate system, and the X-ray phase contrast imaging module 4 and the neutron imaging module 5 form a global coordinate system of the testing apparatus. The local coordinate system and the global coordinate system are unified, and then the specimen 23 is subjected to loading test and characterization.
Step 3. Variable temperature loading of specimen: the temperature of the specimen 23 is controlled and monitored by the variable temperature loading module 3.
Step 4. Mechanical loading of specimen: the two loading arms 20 are used to synchronously carry out tensile loading or compressive loading on both ends of the specimen 23, and meanwhile, the two loading arms 20 rotate synchronously and in the same direction to drive the specimen 23 to rotate by 360° in steps to serve the next imaging.
Step 5. In-situ monitoring of specimen: in-situ monitoring of specimen 23 is implemented by the X-ray phase contrast imaging module 4 and the neutron imaging module 5. An X-ray emitted by an X-ray emitter 40, after passing through the specimen 23, is received by an X-ray receiver 41 to complete X-ray scanning of specimen 23 and achieving X-ray phase contrast imaging. A neutron beam, after hitting the specimen 23 through a neutron beam inlet 105, is received by a neutron beam receiver 50 to complete the CT tomography of the specimen 23 and achieving neutron imaging.
Step 6. Fusion of X-ray characterization image and neutron characterization image: as the X-ray receiver 41 and the neutron beam receiver 50 have different spatial positions, the imaging positions of the X-ray and the neutron on the specimen 23 are different at the same time. Therefore, first, the image obtained and processed by the X-ray receiver 41 and the image obtained and processed by the neutron beam receiver 50 are subjected to time-series registration, that is, the images of the specimen 23 characterized by the X-ray receiver 41 and the neutron beam receiver 50 at the same position and in the same loaded state are registered one-to-one, and then fusion processing is performed to obtain an image with both characterization characteristics of X-ray phase contrast imaging and neutron imaging. Finally, the registered image is reconstructed to obtain a three-dimensional model of the specimen 23 under the corresponding loaded state, thus completing the fusion imaging process of neutron and X-ray.

In an embodiment, as shown in FIG. 1 to FIG. 24, the relevant formulas of mechanical loading test, heat loading test and neutron and X-ray fusion imaging are as follows.
1. In a tensile condition:
The computing formula of stress σ is as follows:

$$σ = \frac{{F}_{1}}{A} \qquad ( 1 )$$

in the formula, F₁ is a tensile force, and A is cross-sectional area of the specimen.
The computing formula of stress ε is as follows:

$$ε = \frac{Δ l}{l} \qquad ( 2 )$$

Δl is elongation of the specimen, and l is an original length of the specimen.
2. In a compressive condition:
The computing formula of stress σ is as follows:

$$σ = \frac{{F}_{2}}{A} \qquad ( 3 )$$

in the formula, F₂ is a compressive force, and A is cross-sectional area of the specimen.
The computing formula of stress E is as follows:

$$ε = \frac{Δ l}{l} \qquad ( 4 )$$

Δl is elongation of the specimen, and I is an original length of the specimen.
3. In a torsional condition:
For a material specimen with circular section:
The computing formula of maximum shear stress τₘₐₓ is as follows:

$${τ}_{max} = \frac{M}{{W}_{p}} \qquad ( 5 )$$

in the formula, M is a torque, and Wₚ is an anti-torsion section coefficient.
The computing formula of a torsional angle φ is as follows:

$$φ = \frac{Ml}{{GI}_{p}} \qquad ( 6 )$$

in the formula, G is shear modulus, and Iₚ is polar moment of inertia of the section.

$${W}_{p} = \frac{π {D}^{3}}{16} \qquad ( 7 )$$

$${I}_{p} = \frac{π {D}^{4}}{32} \qquad ( 8 )$$

in the formula, D is the diameter of the specimen.
For a material specimen with rectangular section:
The computing formula of maximum shear stress τₘₐₓ is as follows:

$${τ}_{max} = \frac{M}{{ahb}^{2}} \qquad ( 9 )$$

in the formula, M is a torque, h is a long edge of the rectangular section, b is a short edge of the rectangular section, and a is a coefficient related to h/b;
The computing formula of a torsional angle φ is as follows:

$$φ = \frac{Ml}{{GI}_{t}} \qquad ( 10 )$$

in the formula, G is shear modulus, and Iₜ is torsional stiffness of the material specimen.

$${I}_{t} = β {hb}^{2} \qquad ( 11 )$$

β is a coefficient related to h/b;
Under a tensile load or a combined compressive-torsional load, the whole surface of the material specimen is the dangerous point, and the computing formula of the equivalent stress of the dangerous point is as follows:

$${σ}_{r 3} = \sqrt{{( \frac{{F}_{1}}{A} )}^{2} + 4 {( \frac{M}{{W}_{p}} )}^{2}} \qquad ( 12 )$$

in the formula: F₁ is an axial tensile force, A is cross-sectional area of the material specimen, M is the torque, and Wₚ is an anti-torsion section coefficient.
4. Under a high (low)-temperature variable temperature loading condition:
The computing formula of the temperature of a metal sample after electric heating is as follows:

$$T = {T}_{0} + \frac{{U}^{2} t}{mcR} \qquad ( 13 )$$

in the formula, TO is an initial temperature, U is a power-on voltage, t is heating time, m is specimen mass, c is specific heat capacity of the specimen, and R is a resistance of the specimen.
A micro-element segment of the material specimen with a length of dx is used for analysis, and the heat of convective heat transfer is as follows:

$${Φ}_{s} = \frac{h ( t - {t}_{f} ) Cdx}{Adx} \qquad ( 14 )$$

in the formula, h is a surface heat transfer coefficient of convective heat transfer, tf is an ambient temperature, C is a circumference of the cross section of the material specimen, and A is the cross-sectional area of the material specimen.
5. The computing formula of an objective fusion quality coefficient of neutron and X-ray fusion imaging is as follows:

$${Q}^{ABF} ( i , j ) = \frac{{{\sum }_{i = 1}}^{m} {{\sum }_{j = 1}}^{n} [ {Q}^{AF} ( i , j ) {w}^{A} ( i , j ) + {Q}^{BF} ( i , j ) {w}^{B} ( i , J ]}{{{\sum }_{i = 1}}^{m} {{\sum }_{j = 1}}^{n} [ {w}^{A} ( i , j ) + {w}^{B} ( i , j ) ]} \qquad ( 15 )$$

in the formula, QAF and QBF are edge preserving values of a neutron characterization image and an X-ray characterization image, respectively; and wA and wB are weight values.

Specific examples are used herein for illustration of the principles and embodiments of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. An in-situ testing apparatus for a material mechanical behavior under neutron and X-ray fusion imaging, comprising:
a positioning support module, comprising a moving base seal coverable of moving spatially, wherein the moving base is provided with a test cassette, a test region for specimen testing is arranged in the test cassette, a left side and a right side of the test cassette are correspondingly provided with a fixture inlet, respectively, and a connecting line between the fixture inlets on the left side and the right side of the test cassette passes through the test region;
a top and a bottom of the test cassette are correspondingly provided with an X-ray outlet and an X-ray inlet, respectively, and a connecting line between the X-ray outlet and the X-ray inlet passes through the test region; a front side and a rear side of the test cassette are correspondingly provided with a neutron beam inlet and a neutron beam outlet, respectively, and a connecting line between the neutron beam inlet and the neutron beam outlet passes through the test region;
a mechanical loading test module, comprising two loading arms seal coverable of rotating around axes thereof, wherein the two loading arms are mounted on the moving base, and the two loading arms correspond to the fixture inlets on the left side and the right side of the test cassette, respectively; the axes of the two loading arms are coaxial and horizontally arranged, an adjustable clamping spacing is formed between the two loading arms, each loading arm is provided with a fixture located in the clamping spacing, and a pressure sensor is arranged between the loading arm and the fixture, and the fixtures of the two loading arms are used to clamp both ends of the specimen, respectively;
a variable temperature loading module, used to control and monitor a temperature of the specimen, wherein the variable temperature loading module is arranged on the moving base;
an X-ray phase contrast imaging module, comprising an X-ray emitter, and an X-ray receiver, wherein the X-ray emitter and the X-ray receiver are mounted on the moving base, and located at a lower side and an upper side of the test cassette, respectively; the X-ray emitter is used to emit an X-ray to the X-ray inlet, and the X-ray receiver is used to receive the X-ray emitted from the X-ray outlet; and
a neutron imaging module, comprising a neutron beam receiver, wherein the neutron beam receiver is mounted on the moving base, and located at a rear side of the test cassette, and used to receive a neutron beam emitted from the neutron beam outlet.

2. The in-situ testing apparatus for a material mechanical behavior under neutron and X-ray fusion imaging according to claim 1, wherein the positioning support module further comprises a portal truss, the X-ray receiver is mounted at the top of the portal truss, and the moving base is mounted on the test cassette through a support frame.

3. The in-situ testing apparatus for a material mechanical behavior under neutron and X-ray fusion imaging according to claim 2, wherein the moving base comprises a bottom walking platform, a vertical moving platform, a longitudinal moving platform, and a transverse moving platform; the bottom walking platform is placed on the ground through universal wheels with anchors, the vertical moving platform is mounted on the bottom walking platform through a height adjusting mechanism, the longitudinal moving platform is mounted on the vertical moving platform through a horizontal longitudinal moving mechanism, and a horizontal longitudinal direction is parallel to a direction of change of the clamping spacing; the transverse moving platform is mounted on the longitudinal moving platform through a horizontal transverse moving mechanism, and a horizontal transverse direction is perpendicular to the direction of change of the clamping spacing; and the portal truss, the support frame and the loading arm are all arranged on the transverse moving platform.

4. The in-situ testing apparatus for a material mechanical behavior under neutron and X-ray fusion imaging according to claim 3, wherein the height adjusting mechanism comprises a height adjusting handwheel, an adjusting bearing housing, three gearboxes, and four worm-gear elevators; the four worm-gear elevators are arranged on the bottom walking platform in a rectangular shape, the adjusting bearing housing is mounted on the bottom walking platform, and a rotating rod is rotatably connected to the adjusting bearing housing; the height adjusting handwheel is connected to an input port of one of the gearboxes through the rotating rod; two of the four worm-gear elevators form one group; and output ports of the gearbox between two worm-gear elevators in one group are connected to the two worm-gear elevators in the group through one transmission rod, respectively, and two output ports of the gearbox connected to the rotating rod are connected to input ports of the other two gearboxes through transmission shafts, respectively.

5. The in-situ testing apparatus for a material mechanical behavior under neutron and X-ray fusion imaging according to claim 3, wherein the horizontal longitudinal moving mechanism comprises a longitudinal adjusting seat, a longitudinal adjusting lead screw, a longitudinal adjusting handwheel, and two longitudinal linear guide rails in horizontal longitudinal arrangement; the longitudinal adjusting seat is fixedly connected to the vertical moving platform, the longitudinal adjusting lead screw is threaded to the longitudinal adjusting seat, and the longitudinal adjusting lead screw is horizontally and longitudinally arranged; and the longitudinal adjusting handwheel is fixedly connected to the longitudinal adjusting lead screw, and the longitudinal adjusting lead screw is rotatably connected to the longitudinal moving platform.

6. The in-situ testing apparatus for a material mechanical behavior under neutron and X-ray fusion imaging according to claim 3, wherein the horizontal longitudinal moving mechanism comprises a transverse adjusting seat, a transverse adjusting lead screw, a transverse adjusting handwheel, and two transverse linear guide rails in horizontal transverse arrangement; the transverse adjusting seat is fixedly connected to the longitudinal moving platform, the transverse adjusting lead screw is threaded to the transverse adjusting seat, and the transverse adjusting screw is arranged horizontally and transversely; and the transverse adjusting handwheel is fixedly connected to the transverse adjusting lead screw, and the transverse adjusting lead screw is rotatably connected to the transverse moving platform.

7. The in-situ testing apparatus for a material mechanical behavior under neutron and X-ray fusion imaging according to claim 3, wherein the loading arm comprises a loading base, a mechanical rotary table, a loading rod, a support bearing housing, and an electric telescopic cylinder with a built-in grating; the loading base is mounted on the moving base, the loading rod is arranged around a cylinder block of the electric telescopic cylinder, one end of the loading rod is connected to an output end of the mechanical rotary table through an adapter plate, and the other end of the loading rod is fixedly connected to an inner ring of a support bearing in the support bearing housing; the support bearing housing is mounted on the moving base, the cylinder block of the electric telescopic cylinder is fixedly connected to the inner ring of the support bearing, and a piston rod of the electric telescopic cylinder is connected to the fixture through the pressure sensor.

8. The in-situ testing apparatus for a material mechanical behavior under neutron and X-ray fusion imaging according to claim 7, wherein the loading base comprises an I-shaped steel plate, an L-shaped steel plate, and a mounting bracket; a lower flange of the I-shaped steel plate is mounted on the moving base, and a transverse plate segment of the L-shaped steel plate is mounted on an upper flange of the I-shaped steel plate; the mechanical rotary table is mounted on the transverse plate segment of the L-shaped steel plate, the mechanical rotary table is abutted against a vertical plate segment of the L-shaped steel plate, the mounting bracket is mounted on the transverse plate segment of the L-shaped steel plate, and the support bearing housing is mounted on the transverse plate segment of the L-shaped steel plate.

9. The in-situ testing apparatus for a material mechanical behavior under neutron and X-ray fusion imaging according to claim 7, wherein the pressure sensor is fixed to the piston rod of the electric telescopic cylinder through a sensor fixing part, and the pressure sensor is connected to the fixture through a sensor fixing shaft.

10. The in-situ testing apparatus for a material mechanical behavior under neutron and X-ray fusion imaging according to claim 8, wherein the fixture comprises two semi-circular jackets seal coverable of being combined with each other, and each semi-circular jacket comprises a first clamping end, and a second clamping end; the first clamping end is used for being sleeved on the sensor fixing shaft, an outer wall of the first clamping end is provided with locking threads for being threaded to a locking nut, and an inner wall of the second clamping end is provided with an arc-shaped limit plate; a sleeve opening seal coverable of being sleeved on the specimen is arranged between the arc-shaped limit plates of the two combined semi-circular jackets; and an end of the specimen is provided with an anti-off convex ring with a diameter greater than that of the sleeve opening.

11. The in-situ testing apparatus for a material mechanical behavior under neutron and X-ray fusion imaging according to claim 1, wherein the variable temperature loading module is mounted on the moving base, and comprises a refrigerating unit, a heating unit, and a temperature measuring unit; the refrigerating unit comprises a nitrogen gas source, the test cassette is provided with a nitrogen inlet and a nitrogen outlet, and the nitrogen inlet communicates with the nitrogen gas source; the heating unit comprises an electrified wire connected to a power supply, the fixture is an insulating fixture, the insulating fixture is provided with an electrified wire inlet, and the electrified wire extends into the insulating fixture through the electrified wire inlet; and the insulating fixture is used for crimping the electrified wire with the specimen, and the temperature measuring unit is mounted in the test cassette.

12. The in-situ testing apparatus for a material mechanical behavior under neutron and X-ray fusion imaging according to claim 11, wherein the temperature measuring unit comprises an infrared thermometer mounted in the test cassette, the test cassette is provided with a test wire inlet, and the infrared thermometer is electrically connected to an external test wire through the test wire inlet.

13. The in-situ testing apparatus for a material mechanical behavior under neutron and X-ray fusion imaging according to claim 2, wherein the X-ray phase contrast imaging module further comprises a vertical linear sliding table, a vertical slider, a receiver mounting plate, and an emitter mounting table; the vertical linear sliding table is vertically mounted at the top of the portal truss, the vertical slider is slidingly connected to the vertical linear sliding table, the X-ray receiver is mounted on the vertical linear sliding table through the receiver mounting plate, the emitter mounting table is mounted on the moving base, and the X-ray emitter is mounted on the emitter mounting table.

14. The in-situ testing apparatus for a material mechanical behavior under neutron and X-ray fusion imaging according to claim 2, wherein the neutron imaging module further comprises a transverse linear sliding table, a transverse slider, and a neutron mounting table; the neutron mounting table is mounted on the moving base, the transverse linear sliding table is mounted on the neutron mounting table, the transverse slider is slidingly connected to the transverse linear sliding table, and the neutron beam receiver is mounted on the transverse slider.

15. The in-situ testing apparatus for a material mechanical behavior under neutron and X-ray fusion imaging according to claim 14, wherein the neutron beam receiver comprises a fluorescent screen, an optical path black box, and a receiving camera; and the fluorescent screen is mounted at an input end of the optical path black box, and the receiving camera is mounted at an output end of the optical path black box.

16. The in-situ testing apparatus for a material mechanical behavior under neutron and X-ray fusion imaging according to claim 14, wherein the test cassette comprises a darkroom cavity, and a darkroom seal cover; a front side of the darkroom cavity is provided with a pick-and-place opening for picking and placing the specimen; the darkroom seal cover is hinged at the pick-and-place opening; the fixture inlets are arranged at the left and right sides of the darkroom cavity; the X-ray outlet and the X-ray inlet are arranged at the top and bottom of the darkroom cavity, respectively; the neutron beam inlet is arranged on the darkroom seal cover; and the neutron beam outlet is arranged at a rear side of the darkroom cavity.

17. The in-situ testing apparatus for a material mechanical behavior under neutron and X-ray fusion imaging according to claim 16, wherein each of the darkroom cavity and the darkroom seal cover is made of ceramics.

18. The in-situ testing apparatus for a material mechanical behavior under neutron and X-ray fusion imaging according to claim 16, wherein the darkroom cavity is connected to the darkroom seal cover by a lock.

19. The in-situ testing apparatus for a material mechanical behavior under neutron and X-ray fusion imaging according to claim 16, wherein the X-ray outlet, the X-ray inlet, the neutron beam inlet and the neutron beam outlet are all aluminum alloy interfaces.
